(19) United States
(12) Patent Application Publication
(10) Pub. No.: US 2010/0006788 A1
(43) Pub. Date: Jan. 14, 2010

(54) VALVE ASSEMBLY HAVING MAGNETICALLY-ENERGIZED SEAL MECHANISM

(75) Inventors: Justin A. Tanner, Queen Creek, AZ (US); Ross Meyer, Apache Junction, AZ (US); Todd Garrod, Gilbert, AZ (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/170,179

(22) Filed: Jul. 9, 2008

(51) Int. Cl. F16K 31/06

(52) U.S. Cl. 251/65

(57) ABSTRACT

A valve assembly is provided that includes a flowbody, a valve element movably disposed within the flowbody, and a magnetically-energized seal mechanism. The magnetically-energized seal mechanism includes a wiper seal carried by one of the flowbody and the valve element and movable between a retracted position and an extended position. A first magnetic element is fixedly coupled to the wiper seal, and a second magnetic element is fixedly coupled to one of the flowbody and the valve element. The second magnetic element magnetically repels the first magnetic element to bias the wiper seal toward the extended position.

### TECHNICAL FIELD

The present invention relates generally to sealing valve assemblies and, more particularly, to a valve assembly employing a magnetically-energized seal mechanism.

### BACKGROUND

Sealing valve assemblies are utilized to control the flow of pressurized fluids in many high pressure applications. For example, in an aircraft cabin pressure regulation system, a sealing flap valve assembly may be utilized to regulate the flow of pressurized air from the fuselage's interior to the ambient environment outside of the aircraft. A generally representative sealing flap valve assembly includes a flap door that is hingedly mounted within a flowbody and movable between an open, a closed position, and various intermediate positions. A wiper seal (e.g., an elongated polymeric strip) is affixed to an outer peripheral edge of the flap door. As the flap door swings into the closed position, the wiper seal sweeps across an inner surface of the flowbody to form a seal that substantially prevents the leakage of pressurized fluid across the closed flap door.

In many high pressure applications, it is desirable to enhance the sealing characteristics of a sealing flap valve assembly by spring biasing the wiper seal away from the flap door (or other such valve element) and into sealing engagement with the flowbody's inner surface (commonly referred to as “energizing” the wiper seal). In such a case, the wiper seal may be disposed within a slot provided in an outer peripheral portion of the flap door. The wiper seal may slide within this slot between a retracted position and an extended position. A spring, such as a wave spring or a resilient wire form, is further disposed within the slot and compressed between an inner surface of the flap door and the wiper seal. The spring biases the wiper seal away from the flap door and toward the extended position. When the flap door swings into a closed position, the wiper seal sealingly engages the flowbody's inner surface, which forces the wiper seal toward the retracted position. This further compresses the spring within the slot and thus increases the bias force exerted on the wiper seal by the spring. As a result, the wiper seal forms a better seal with the flowbody's inner surface across a greater range of the flap door's rotational path.

Although enhancing sealing between the wiper seal and the flowbody's inner surface, valve assemblies including spring-energized seal mechanisms of the type described above are associated with certain limitations. For example, such spring-energized seal mechanisms may be relatively difficult and costly to assemble. The reliability of such spring-energized seal mechanism is often negatively impacted by high frictional characteristics and limited spring life cycles. Furthermore, conventional spring-energized seal mechanisms do not permit the spring bias force exerted on the wiper seal to be adjusted during valve operation.

It is thus desirable to provide a sealing valve assembly, such as a sealing flap valve assembly, having an energized wiper seal that is relatively easy and inexpensive to produce. Preferably, such a sealing valve assembly would minimize friction and operate in a reliable manner. It would also be desirable if, in certain embodiments, such a sealing valve assembly permitted adjustment of the bias force exerted on the energized wiper seal during valve operation. Other desirable features and characteristics of the present invention will become apparent from the subsequent Detailed Description and the appended claims, taken in conjunction with the accompanying drawings and this Background.

### BRIEF SUMMARY

A valve assembly is provided that includes a flowbody, a valve element movably disposed within the flowbody, and a magnetically-energized seal mechanism. The magnetically-energized seal mechanism includes a wiper seal carried by one of the flowbody and the valve element and movable between a retracted position and an extended position. A first magnetic element is fixedly coupled to the wiper seal, and a second magnetic element is fixedly coupled to one of the flowbody and the valve element. The second magnetic element magnetically repels the first magnetic element to bias the wiper seal toward the extended position.

### BRIEF DESCRIPTION OF THE DRAWINGS

At least one example of the present invention will hereinafter be described in conjunction with the following figures, wherein like numerals denote like elements, and:

FIGS. 1, 2, and 3 are simplified cross-sectional views of a valve assembly including first and second magnetically-energized seal mechanisms in non-sealing, a first sealing, and second sealing positions, respectively, in accordance with a first exemplary embodiment;

FIGS. 4 and 5 are functional isometric views of a magnetically-energized seal mechanism in a non-sealing position and a sealing position, respectively, in accordance with a second exemplary embodiment;

FIG. 6 is a functional isometric view of the magnetically-energized seal mechanism shown in FIGS. 4 and 5 illustrating one manner in which an actuator may be utilized to adjust the magnetic bias force exerted on the wiper seal; and

FIGS. 7 and 8 are isometric cross-sectional views of a valve assembly including a magnetically-energized seal mechanism in a non-sealing position and a sealing position, respectively, in accordance with a third exemplary embodiment.

### DETAILED DESCRIPTION

The following Detailed Description is merely exemplary in nature and is not intended to limit the invention or the application and uses of the invention. Furthermore, there is no intention to be bound by any theory presented in the preceding Background or the following Detailed Description.

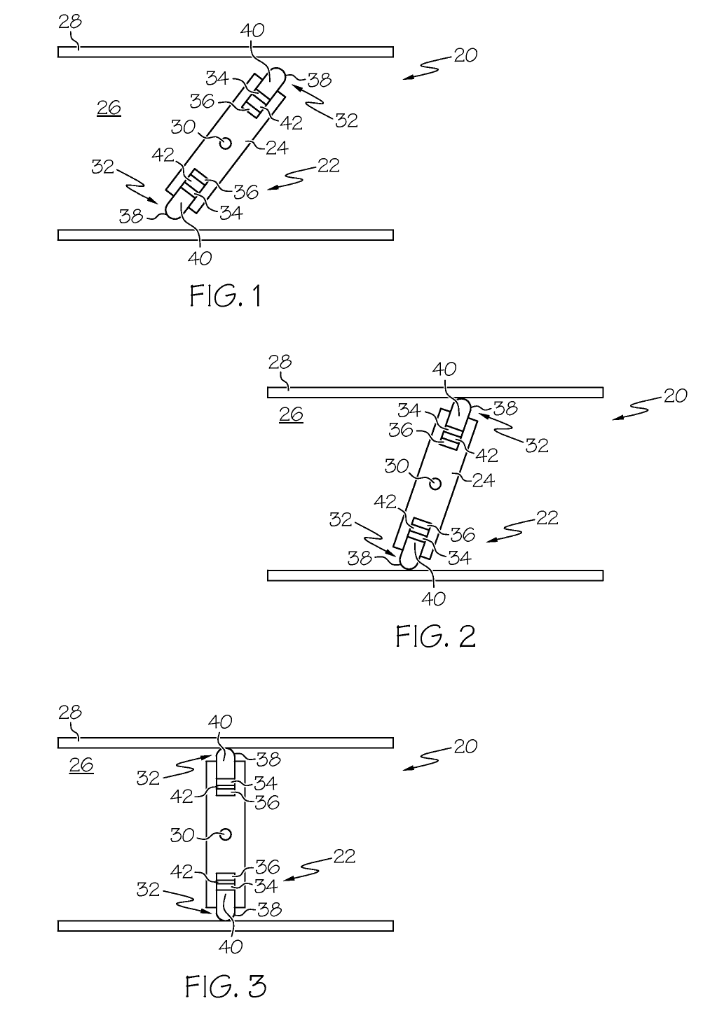

FIGS. 1, 2, and 3 are simplified cross-sectional views of a valve assembly 20 having at least one magnetically-energized seal mechanism 22 in accordance with a first exemplary embodiment. Valve assembly 20 includes a valve element 24 that is movably disposed within a main flow passage 26 provided through a flowbody 28. In the illustrated exemplary embodiment, valve element 24 assumes the form of a butterfly plate is rotatably mounted within flow passage 26 as indicated in FIGS. 1-3 at 30. In this case, valve element 24 be substantially rectangular in shape and have first and second seal mechanisms 22 mounted to opposing ends thereof as shown in FIGS. 1-3. This example notwithstanding, valve element 26 may assume various other forms, as well; e.g., a flap door hingedly mounted within flowbody 28. Valve element 24 is movable amongst an open position (FIG. 1), a closed position (FIG. 3), and various intermediate positions (FIG. 2). During operation of valve assembly 20, valve element 24 may be moved amongst these positions by a non-illustrated valve actuator to regulate the flow of pressurized fluid through flowbody 28. Alternatively, valve element 24 may be biased toward the closed position (FIG. 3) by a non-illustrated torsion spring.

In the exemplary embodiment shown in FIGS. 1-3, each magnetically-energized seal mechanism 22 is incorporated into valve element 24 and comprises three main components: (i) a movable wiper seal 32, (ii) a first magnetic element 34 fixedly coupled to wiper seal 32, and (iii) a second magnetic element 36 fixedly coupled to valve element 24 substantially opposite first magnetic element 34. Each wiper seal 32 includes a first end portion 38, which sealing engages an inner surface of flowbody 28 in the closed position (FIG. 3) and certain intermediate positions (FIG. 2), and a second end portion 40 substantially opposite first end portion 38. As valve element 24 rotates from the open position (FIG. 1) to the closed position (FIG. 3), each wiper seal 32 sweeps across an inner surface of flowbody 28. To facilitate this sweeping motion, first end portion 38 of each wiper seal 32 may have a generally rounded cross-sectional shape. In addition, first end portion 38, and perhaps the entire body of each wiper seal 32, may be formed from a flexible polymeric material, such as ultra high molecular weight polyethylene (UHMWPE), polyoxymethylene (Delrin®), polytetrafluoroethylene (Teflon®), and the like.

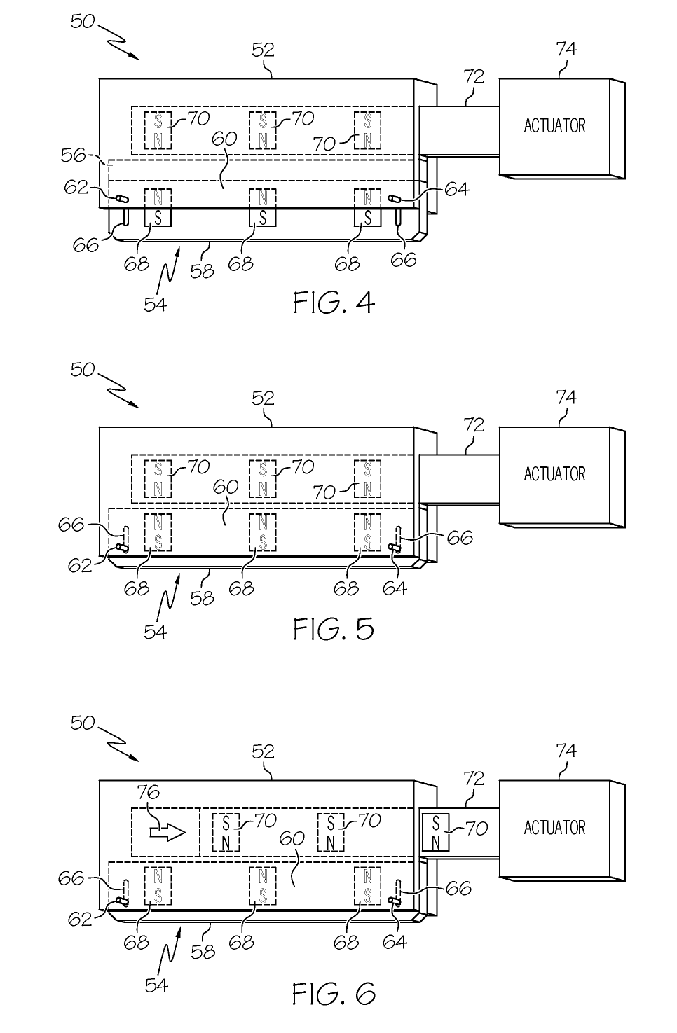

Each wiper seal 32 is slidably coupled to valve element 24. In particular, second end portion 40 of each wiper seal 32 is received by a different longitudinal cavity or slot 42 provided within an outer peripheral portion of valve element 24. Each wiper seal 32 may move within its respective slot 42 amongst an extended position (FIG. 1), a retracted position (FIG. 3), and various intermediate positions (FIG. 2). As described below, magnetic elements 34 and 36 cooperate to magnetically bias each wiper seal 32 toward the extended position shown in FIG. 1. Although not shown in FIGS. 1-3 for clarity, one or more guide members may also be fixedly coupled to valve element 24 to guide the movement of each wiper seal 32 and to retain end portion 40 of each wiper seal 32 within its slot 42. An example of such a guide member is described below in conjunction with FIGS. 4 and 5.

As noted above, first magnetic elements 34 and second magnetic elements 36 are fixedly coupled to wiper seal 32 and to valve element 24, respectively. In the exemplary embodiment illustrated in FIGS. 1 and 2, a first magnetic element 34 is disposed within (e.g., embedded within, mounted into counter-bores provided in, etc.) second end portion 40 of each wiper seal 32, and a second magnetic element 36 is disposed within or mounted to the frame of valve element 24 proximate the bottom of each longitudinal slot 42. Second magnetic elements 36 are positioned so as to magnetically oppose (i.e., repel) first magnetic elements 34. In certain embodiments, first magnetic elements 34 and/or second magnetic elements 36 may comprise one or more electromagnets; however, in a preferred group of embodiments, magnetic elements 34 and 36 each assume the form of a permanent magnet. The particular shape, magnetization, orientation, and material selected for magnetic elements 34 and 36 will inevitably vary amongst different embodiments. As a first non-limiting example, magnetic elements 34 and 36 may comprise rare-earth (e.g., neodymium, samarium-cobalt, etc.) rods axially magnetized and arranged end to end with like poles adjacent one another. As a second non-limiting example, magnetic elements 34 and 36 may comprise rare-earth (e.g., neodymium, samarium-cobalt, etc.) discs radially magnetized and arranged edge to edge with like poles adjacent one another.

Due to their mutual repulsion, magnetic elements 34 and 36 bias each wiper seal 32 away from valve element 24 and toward the extended position shown in FIG. 1. Magnetic elements 34 and 36 consequently bias each wiper seal 32 into sealing engagement with an inner surface of flowbody 28 in the closed position (FIG. 3) and certain intermediate positions (FIG. 2) to substantially prevent fluid leakage across valve element 24. Notably, as valve element 24 rotates into the closed position (FIG. 3), each wiper seal 32 contacts an inner surface of flowbody 28, which forces each wiper seal 32 to move toward its retracted position (FIG. 3). This results in a decrease in the spacing between magnetic elements 34 and 36. As the spacing between the magnetic elements 34 and 36 decreases linearly, the magnitude of the repulsive magnetic force, and thus the bias force exerted on each wiper seal 32, increases exponentially. Thus, in contrast to conventional spring-energized seal mechanisms, magnetically-energized seal mechanisms 22 provide a more pronounced increase in bias force as the valve element rotates into the closed position. In addition, magnetically-energized seal mechanisms 22 do not suffer from the high frictional characteristics and life cycle limitations associated with conventional spring-energized seal mechanisms. As a still further advantage, magnetically-energized seal mechanisms 22 are relatively easy and inexpensive to manufacture.

FIGS. 4 and 5 are functional isometric views of a magnetically-energized seal mechanism 50 in non-sealing and sealing positions, respectively, and slidably mounted within a valve element 52 (e.g., a flapper, a door, a plate, etc.) in accordance with a second exemplary embodiment. For clarity, only a portion of valve element 52 is shown in FIGS. 4 and 5, and the flowbody in which valve element 52 is movably mounted is not shown. In many respects, magnetically-energized seal mechanism 52 is similar to magnetically-energized seal mechanism 20 discussed above in conjunction with FIGS. 1-3. For example, magnetically-energized seal mechanism 50 includes an elongated wiper seal 54 that is slidably disposed within a longitudinal slot 56 (labeled in FIG. 4) provided with an outer peripheral portion of valve element 52. Elongated wiper seal 54 includes a sealing end portion 58, which may have a substantially rounded edge, and an opposing end portion 60. As was the case previously, elongated wiper seal 54 is movable amongst an extended position (FIG. 4), a retracted position (FIG. 5), and a plurality of intermediate positions. First and second guide members 62 and 64 are fixedly coupled to valve element 52. In this example, guide members 62 and 64 each assume the form of a post that extends through a corresponding slot 66 provided through wiper seal 54. This example notwithstanding, it will be appreciated that guide members 62 and 64 may assume any form suitable for guiding the movement of wiper seal 54 and/or retaining end portion 60 of wiper seal 54 within slot 56.

In a preferred group of embodiments, a first plurality of magnetic elements is fixedly coupled to wiper seal 54, and a second plurality of magnetic elements is disposed within valve element 52 proximate slot 56 and substantially opposite the first plurality of magnetic elements. In the exemplary embodiment shown in FIGS. 4 and 5, specifically, three permanent magnets 68 are disposed within (e.g., press fit into counter-bores provided within) end portion 60 of wiper seal 54, and a three permanent magnets 70 are disposed within (e.g., mounted into counter-bores provided within) valve element 52 near the bottom of slot 56 opposite magnets 68. Magnets 68 and 70 may assume any suitable particular shape, magnetization, or orientation provided that magnets 68 generally repel magnets 70. In the example shown in FIGS. 4 and 5, magnets 68 and magnets 70 each assume the form of axially magnetized rods arranged end-to-end with like poles adjacent. Magnets 68 and 70 are preferably distributed along the longitudinal axis of elongated wiper seal 54 such that each magnet 68 substantially aligns with and repels a different magnet 70; e.g., magnets 70 may be laterally spaced along the bottom of longitudinal slot 56 as shown in FIGS. 4 and 5. Due to the repulsive force exerted on magnets 68 by magnets 70, wiper seal 54 is biased away from valve element 52 and toward the extended position (FIG. 4). Thus, as valve element 52 rotates into a closed position, magnets 68 and 70 cooperate to force wiper seal 54 into sealing engagement with the inner surface of the flowbody in which valve element 52 is mounted (e.g., flowbody 28 shown in FIGS. 1-3).

Although by no means necessary, magnetically-energized seal mechanism 50 may further include a means for altering the magnitude of the repulsive force exerted by magnets 70 on magnets 68. For example, and with additional reference to FIG. 6, magnets 70 may be carried by a rail 72 that is slidably mounted within the main body or frame of valve element 52. An actuator 74 is mechanically coupled to rail 72 and may move rail 72 laterally between a first position (FIGS. 4 and 5) wherein magnets 70 align with magnets 68 and a second position (FIG. 6) wherein magnets 70 are laterally offset from magnets 68. Actuator 74 may include, for example, a drive motor (e.g., an electric, hydraulic, or pneumatic device) that drives a pinion, which engages a toothed surface formed on rail 72. As indicated in FIG. 6 by arrow 76, actuator 74 may selectively move rail 72 between the first position (FIGS. 4 and 5) and the second position (FIG. 6) to increase or decrease the distance between magnets 68 and 70 and thereby increase or decrease, respectively, the magnetic bias force exerted on wiper seal 54.

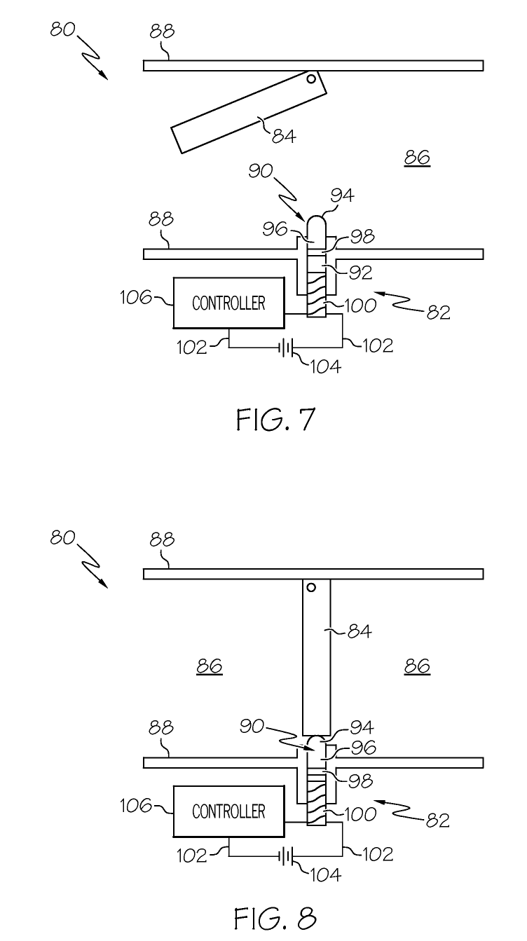

FIGS. 7 and 8 are simplified cross-sectional views of a valve assembly 80 having a magnetically-energized seal mechanism 82 in non-sealing and sealing positions, respectively, in accordance with a third exemplary embodiment. Valve assembly 80 is similar to valve assembly 20 described above in conjunction with FIGS. 1-3; e.g., valve assembly 80 includes a valve element 84 (e.g., a flap door) that is hingedly mounted within a main flow passage 86 provided through a flowbody 88. However, in contrast to valve assembly 20, seal mechanism 82 is not integrated into valve element 84 and is instead integrated into flowbody 88. In this example, seal mechanism 82 comprises a wiper seal 90 that is movably disposed within a cavity 92 provided within a wall of flowbody 88. Wiper seal 90 includes a sealing end portion 94, which may have a substantially rounded edge to facilitate contact with the peripheral edge of valve element 84 as valve element 84 swings closed, and an opposing end portion 96. Wiper seal 90 is movable between an extended position (FIG. 7), a retracted position (FIG. 8), and various intermediate positions. At least one magnetic element, in this case a permanent magnet 98, is fixedly coupled to wiper seal 90 (e.g., mounted within or to opposing end portion 96); and at least a second magnetic element 100 is disposed within cavity 92 substantially opposite permanent magnet 98. Second magnetic element 100 is configured to repel permanent magnet 98 to thereby bias wiper seal 90 into flow passage 86 and toward the extended position (FIG. 7). When valve element 84 rotates into the closed position (FIG. 8), magnet 98 and magnetic element 100 cooperate to bias wiper seal 90 into sealing engagement with the peripheral edge of valve element 84. As a result of this magnetic bias force, wiper seal 90 forms a more complete seal with valve element 84 in the closed position shown in FIG. 8 and, perhaps, in other near closed positions.

It should thus be appreciated that valve assembly 80 differs from valve assembly 20 (FIGS. 1-3) in that magnetically-energized seal mechanism 82 is integrated into flowbody 88 as opposed to valve element 84. However, this is not the only manner in which valve assembly 80 differs from valve assembly 20; in the exemplary embodiment shown in FIGS. 7 and 8, magnetic element 100 comprises at least one electromagnet (“electromagnet 100”). The coil of electromagnet 100 is electrically coupled to a power source 104 (e.g., a battery) by electrical conductors 102. Valve assembly 80 may be configured such that power source 104 supplies electromagnet 100 with a continuous current. In this case, the repulsive force exerted by electromagnet 100 on permanent magnet 98 may be substantially constant. Alternatively, and as shown in FIGS. 7 and 8, a controller 106 may be operatively coupled between electromagnet 100 and power source 104. Controller 106 may be configured to selectively vary the current supplied to electromagnet 100 to increase or decrease the magnitude of the repulsive force exerted by electromagnet 100 on permanent magnet 98. In this manner, controller 106 may adjust the magnetic bias force exerted on wiper seal 54 during operation to accommodate, for example, changes in operating conditions.

Considering the above, it should be appreciated that there has been provided various embodiments of a valve assembly including a magnetically-energized seal mechanism that minimizes friction, that operates in a reliable manner, and that is relatively easy and inexpensive to produce. It should also be appreciated that, in certain embodiments, the valve assembly enables the bias force exerted by the magnetically-energized seal mechanism to be adjusted during operation. Although generally described in the foregoing exemplary embodiments as permanent magnets, any number of the magnetic elements disposed within the valve element and/or the magnetic elements carried by the wiper seal may assume the form of electromagnets (e.g., electromagnet 100 described in conjunction with FIGS. 7 and 8). In addition, the magnetic elements carried by the wiper seal may comprise magnetic particles that are embedded into selected portions of the wiper seal utilizing conventional doping processes. Lastly, it should be noted that the wiper seal may assume a curved or arcuate shape in embodiments wherein the inner surface of the flowbody and/or the peripheral edge of the valve element is curved (e.g., when the valve element assumes the form of a butterfly plate having a generally circular or oval circumferential shape).

While at least one exemplary embodiment has been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention. It being understood that various changes may be made in the function and arrangement of elements described in an exemplary embodiment without departing from the scope of the invention as set-forth in the appended claims.

What is claimed is:

1. A valve assembly, comprising:
a flowbody;
a valve element movably disposed within the flowbody; and
a magnetically-energized seal mechanism, comprising:
a wiper seal carried by one of the flowbody and the valve element and movable between a retracted position and an extended position;
a first magnetic element fixedly coupled to the wiper seal; and
a second magnetic element fixedly coupled to one of the flowbody and the valve element, the second magnetic element magnetically repelling the first magnetic element to bias the wiper seal toward the extended position.

2. A valve assembly according to claim 1 wherein the magnetically-energized seal mechanism is integrated into the valve element.

3. A valve assembly according to claim 1 wherein the magnetically-energized seal mechanism is integrated into the flowbody.

4. A valve assembly according to claim 1 wherein the first magnetic element and the second magnetic element each comprise a permanent magnet.

5. A valve assembly according to claim 1 wherein the first magnetic element comprises a permanent magnet, and wherein the second magnetic element comprises an electromagnet.

6. A valve assembly according to claim 5 further comprising a controller operatively coupled to the electromagnet and configured to vary the current supplied thereto to alter the magnet force biasing the wiper seal toward the extended position.

7. A valve assembly according to claim 2 wherein the valve element comprises a longitudinal slot, and wherein the wiper seal comprises:
a first end portion configured to sealingly engage an inner surface of the flowbody; and
a second end portion disposed substantially opposite the first end portion and slidably received within the longitudinal slot.

8. A valve assembly according to claim 7 wherein the first end portion is generally rounded.

9. A valve assembly according to claim 7 wherein the first magnetic element is fixedly coupled to the second end portion.

10. A valve assembly according to claim 9 wherein the first magnetic element is disposed within the second end portion.

11. A valve assembly according to claim 9 wherein the second magnetic element is disposed within the valve element proximate the longitudinal slot and substantially opposite the first magnetic element.

12. A valve assembly according to claim 7 further comprising a guide member fixedly coupled to the valve element and configured to guide the movement of the wiper seal within the longitudinal slot.

13. A valve assembly according to claim 1 wherein the valve element further comprises a rail to which the first magnetic element is fixedly coupled, and wherein the magnetically-energized seal mechanism further comprises an actuator operatively coupled to the rail and configured to selectively move the rail to adjust the distance between the first magnetic element and the second magnetic element.

14. A valve assembly, comprising:
a flowbody;
a valve element movably disposed within the flowbody; and
a magnetically-energized seal mechanism, comprising:
a wiper seal slidably coupled to the valve element and movable between a retracted position and an extended position;
a first plurality of permanent magnets fixedly coupled to the wiper seal; and
at least one magnetic element fixedly coupled to the valve element, the at least one magnetic element in magnetic opposition with the first plurality of permanent magnets and biasing the wiper seal away from the valve element and toward the extended position.

15. A valve assembly according to claim 14 wherein the at least one magnetic element comprises a second plurality of permanent magnets fixedly coupled to the valve element.

16. A valve assembly according to claim 15 wherein the first plurality of permanent magnets and the second plurality of permanent magnets are each substantially distributed along the longitudinal axis of the wiper seal.

17. A valve assembly according to claim 16 each permanent magnet in the first plurality of permanent magnets substantially aligns with a different magnet in the second plurality of permanent magnets.

18. A valve assembly according to claim 15 wherein the valve element comprises a flap door hingedly mounted within the flowbody and including a longitudinal slot formed in an outer peripheral portion thereof, the wiper seal slidably disposed within the longitudinal slot.

19. A valve assembly according to claim 18 wherein the second plurality of permanent magnets is laterally spaced along the bottom of the longitudinal slot.

20. A valve assembly, comprising:
a flowbody;
a valve element movably disposed within the flowbody; and
a magnetically-energized seal mechanism, comprising:
an elongated wiper seal slidably coupled to the valve element and movable between a retracted position and an extended position;
a first plurality of permanent magnets fixedly coupled to the wiper seal and generally distributed along the longitudinal axis thereof; and
a second plurality of permanent magnets fixedly coupled to the valve element, the second plurality of permanent magnets aligning with the first plurality of permanent magnets and cooperating therewith to magnetically bias the wiper seal away from the valve element and toward the extended position.
